(19) United States
(12) Patent Application Publication
(10) Pub. No.: US 2009/0003231 A1
(43) Pub. Date: Jan. 1, 2009

(54) Transparent signaling agent

(76) Inventors: Jeffrey A. Hawbaker, Naperville, IL (US); Robert J. Laidlaw, McKinney, TX (US); Jonathan B. Sadler, Naperville, IL (US); Dale A. Scholtens, Lisle, IL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/012,208

(22) Filed: Jan. 31, 2008

Related U.S. Application Data
(63) Continuation of application No. PCT/US2007/013555, filed on Jun. 6, 2007.

(51) Int. Cl. H04L 12/26

(52) U.S. Cl. 370/252

(57) ABSTRACT

In today's network, enhancing or otherwise modifying signals in bearer flows in or at equipment already deployed in a network may be done by modifying or upgrading existing equipment, or otherwise invasively routing signals through identified network elements. In accordance with example embodiments of the present invention, signals for control plane flows are transparently monitored using policy based routing to direct control signals from a routing point to a signaling monitoring point. Bearer plane address information of a selected media processing point is substituted for other bearer plane address information in the control signal in a manner that causes subsequent bearer flows to be directed to the selected media processing point from the routing point by destination based routing. Bearer flows may be directed to a media processing point to apply signal enhancement to an encoded media signal on the bearer flows to produce an enhanced media encoded signal. Such embodiments enable service providers to upgrade networks with media processing in a low-cost, non-invasive manner.

### RELATED APPLICATION

This application is a continuation of International Application No. PCT/US2007/013555, which designated the United States and was filed on Jun. 6, 2007. The entire teachings of the above application are incorporated herein by reference.

### BACKGROUND OF THE INVENTION

In a packet switched network, an end-to-end connection bearing various media services (e.g., voice, video) may be transmitted in the “data plane” by one or more bearer flows, each of which being composed of a packet stream. Collectively, these bearer flows span the end-to-end connection. As such, packet switching elements located along a connection path utilize standard packet switching protocols within the data plane to interconnect composite bearer flows.

Furthermore, an end-to-end connection along with its composite bearer flows are established in accordance with standard signaling protocols (e.g., Session Initiation Protocol (SIP)) conveyed across the “control plane” between the connection endpoints. Within this control plane, a connection controller typically acts as an intermediate signaling agent in directing the establishment of the data plane resident bearer flows supporting the requested connection.

Signaling pursuant to the establishment of an end-to-end connection is typically initiated via an originating node's transmission of a “connection set-up” message (e.g., a SIP INVITE message) to the control plane indicating the address of the intended destination node along with the originating node's selection of various connection attributes. These connection attributes typically include the originating node's selection of various call parameters, along with its selection of the originating node's address parameters to be utilized by subsequent bearer flows. This “connection set-up” message is propagated through one or more intermediary signaling agents via the control plane's underlying packet switching network (again using standard packet switching protocols), and ultimately to the addressed destination node. At this point, the destination node may signal its response to the originating node to the “connection set-up” message indicating its preferred selection of various call parameters, inclusive of the destination node's selection of address parameters to be utilized by data plane resident bearer flows to be subsequently sent to it. In this fashion, the originating and terminating nodes along with intervening signaling agents communicate within the context of the control plane to not only “negotiate” various call parameters, but to establish the composite bearer flows that will subsequently transport the end-to-end connection's media within the data plane.

In many networks, especially wireless networks, service providers are motivated to monitor the connections of its subscribers and to offer differentiating services that not only attract new subscribers, but also provides leverage in preventing churn among existing subscribers. One such set of differentiating services are pertinent in the area of Media Quality Enhancement (MQE). The implementation of these sorts of services within a service provider's network typically requires the application of intermediate media processing functionality somewhere along the path of an end-to-end connection between subscribers.

### SUMMARY OF THE INVENTION

A method or corresponding apparatus in an example embodiment of the present invention transparently monitors signaling messages traversing the “control plane” for the establishment of prospective “data plane” resident connections bearing media types which are to be targeted for intermediate media processing between the connection end nodes. In an example embodiment, the method or corresponding apparatus utilizes Policy Based Routing (PBR) to direct signaling messages from a routing point within the control plane to a signaling monitoring point, also within the control plane. This signaling monitoring point acts as an intermediate signaling agent which first identifies the connection set-up signaling pursuant to the establishment of data plane connections with the media types targeted for media processing. Once so identified, this signaling agent substitutes for the bearer flow address information contained in the signaling messages with bearer flow address information of media processing points in the data plane network such that subsequent bearer flows are directed to the selected media processing points. Once such bearer flow address information has been substituted into the original signaling message, the modified signaling message is presented by the signaling agent back to the control plane's packet switching network, at which point the modified signaling message is forwarded to its original destination by Destination Based Routing (DBR) capabilities inherent to the control plane network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a prior art network in which embodiments of the present invention may be employed.

FIG. 2 is a network diagram illustrating a network including a system in which an embodiment of the present invention may be deployed in Mobile Telephone Switching Office (MTSO) applications.

FIG. 3 is a network diagram of a system for the transparent monitoring of control plane signaling packets as well as the active media processing of data plane bearer packets according to an embodiment of the present invention.

FIG. 4A illustrates an example control plane operations flow to redirect data plane bearer flows.

FIG. 4B illustrates an example message flow implementing the operations flow as specified in FIG. 4A.

FIG. 5 is a packet diagram illustrating examples of control plane signaling packets sent between a connection source and a connection destination with intervening signaling monitoring functions.

FIG. 6 is a packet diagram illustrating examples of data plane bearer packets sent between a connection source and a connection destination with intervening media processing functions.

FIG. 7 is a network diagram illustrating the session initiation protocol dialog flows and the bearer channel flows through a multilayer switching device.

### DETAILED DESCRIPTION OF THE INVENTION

A description of example embodiments of the invention follows.

In today's network, enhancing, processing, or otherwise modifying signals in bearer flows in or at equipment already deployed in a network may be done by modifying or upgrading existing equipment, or otherwise invasively routing signals through identified network elements. In accordance with embodiments of the present invention, control plane signaling is intercepted and transparently monitored using policy based routing to direct connection control signals from a routing point in the control plane to a monitoring point also residing in the control plane. As such, fields contained in the headers of protocols (e.g., at layers 2, 3, and 4) utilized to transport the subject connection control protocol (e.g., Session Initiation Protocol (SIP)) remain unchanged while at the signaling monitoring point in order that the connection control signal may be ultimately forwarded on to its original destination via normal destination based forwarding across routing points within the control plane. While at the signaling monitoring point, addressing parameters of a selected media processing point residing in the data plane is substituted for the data plane addressing parameters originally contained in the connection set-up signal. This causes subsequent bearer flows to be directed to the selected media processing point from a routing point within the data plane by destination based routing once the connection is established. At the time that the media processing point's address substitution occurs, the signaling monitoring point also notifies the selected media processing point of the original data plane address parameters for which substitution occurred. This is so that the media processing point, once it has processed the media contained in a redirected bearer flow, may forward the enhanced media in a bearer flow to its original destination as specified in the original signaling message. Once the signaling monitoring point is through with the connection control signal, the signal (containing its pertinent bearer flow addressing substitutions) is forwarded to its original destination.

In example embodiments of the invention, bearer flows may be directed (as described above) to a media processing point to process encoded media on the bearer flows to monitor metrics associated with the media and/or bearer flows. In other example embodiments of the invention, bearer flows may be directed to a media processing point (again, as described above) to apply media enhancement (e.g., Coded Domain-Media Quality Enhancement (CD-MQE)) to encoded media to produce an enhanced encoded media. In some embodiments of the invention, the bearer flows may be selectively directed to a media processing point depending on the identity of either the sending or receiving party, their service subscriptions, or specific media types. Furthermore, some example embodiments of the invention may be used either within or outside of a single Mobile Telephone Switching Office (MTSO) in Local Access, Backhaul, or Wide Area networking applications.

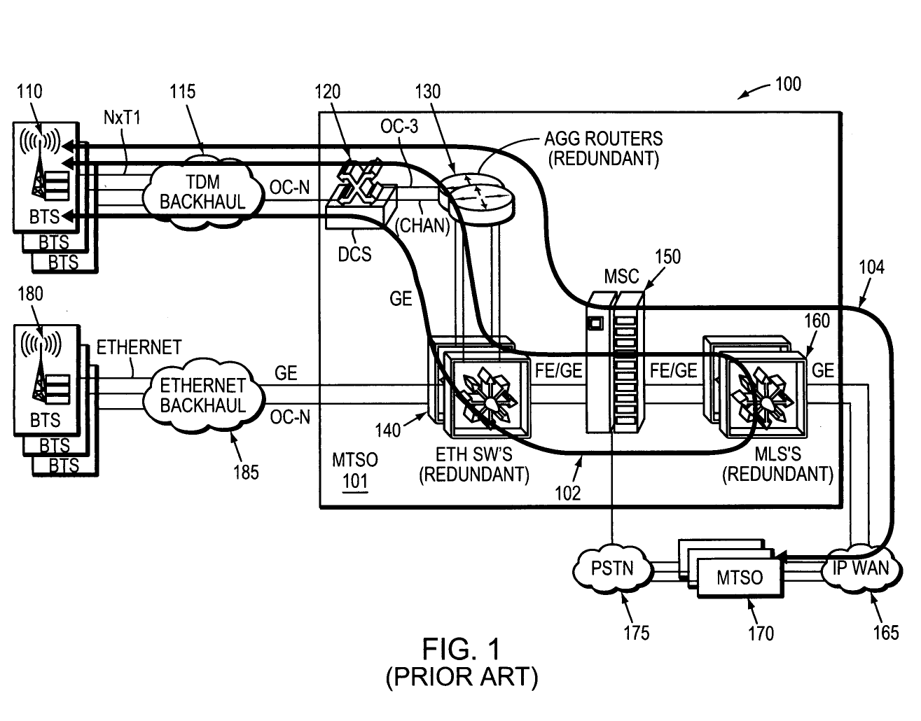

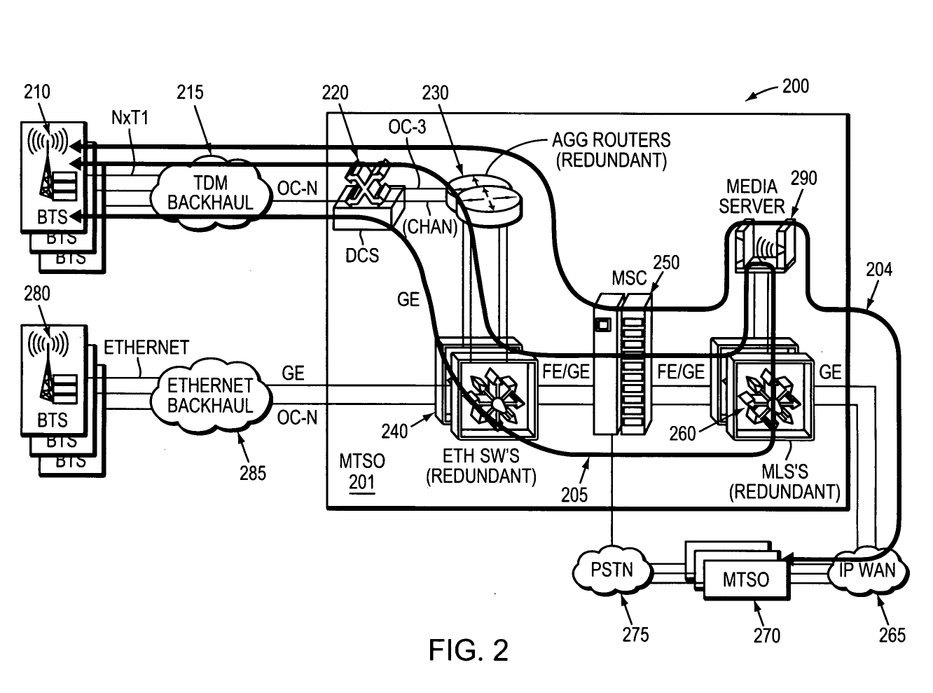

Before describing specific example embodiments of the present invention in reference to FIGS. 2 through 11, a brief description of FIG. 1 is presented to illustrate an example prior art network in which the example embodiments may be deployed.

FIG. 1 illustrates a prior art communications network 100 in which embodiments of the present invention may be employed. In the network 100, base transceiver stations 110 and 180 provide network access to mobile devices (not shown in FIG. 1). As shown in FIG. 1, base transceiver station sites are typically connected to a Mobile Telephone Switching Office 101 (MTSO) through a TDM backhaul network 115 that may include copper, optical fiber, or microwave facilities and communications paths. Copper facilities deliver either T-carrier 1 (T1), sometimes referred to as Digital Signal 1 (DS1), or E-carrier 1 (E1), while microwave and optical fiber facilities can offer T3s or Ethernet in addition to T1 or E1. Alternatively, base transceiver stations 180 may connect to the MTSO 101 through an Ethernet backhaul 185. One of skill in the art will recognize that other transport technologies or other intermediate network elements (not shown) may be used to connect base transceiver stations 110, 180 with the MTSO 101.

The MTSO 101 may include a number of typical networking elements, including cross connect switches 120, aggregation routers 130, and Ethernet switches 140 by which traffic transmitted across multiple backhaul networks 115 and 185 is aggregated towards or distributed from a mobile switching center 150 (MSC). Connections from a mobile device (not shown) served by the local MTSO can be made through the MSC 150 to another mobile device served by the same MTSO 101, to a mobile device served by another MSC in another MTSO 170, or to a landline through the public switched telephone network 175 (PSTN). The MSC 150 may provide a number of services, including mobility management for subscribers (e.g., registration, authentication, authorization for services), media conversion (TDM to packet gateway, media transcoding), and signaling (signaling gateway, signaling transport, connection control). Connection control services determine how connections are set-up and support bearer flows routed to carry the media traffic within the same MTSO 101, to another MTSO 170, or to the PSTN 175. As shown, the PSTN may connect with any number of different MTSOs 101.

Once connection control services have established a connection between mobile devices, the supporting bearer flows may travel through either an “intra-MTSO” or “inter-MTSO” data path. Bearer flow 102 illustrates a connection between mobile devices on base transceiver stations 110 served by the same MTSO 101, also referred to as an intra-MTSO signal flow. Following bearer flow 102, the bearer flow is sent through the base transceiver station 110 through the T1 backhaul 115 to a digital cross connect 120 in the MTSO 101. At the MTSO 101, the bearer flow 102 is directed by a router 130 to an Ethernet switch 140 to the MSC 150. The MSC 150 sends the connection to a multilayer switching (MLS) device 160. At the MLS 160, the Intra-MTSO bearer flow is routed back to the MSC 150 from which the bearer flow traverses the reverse direction across the Ethernet switch 140, router 130, cross connect 120, across the T1 backhaul 115, and on to the destination base transceiver station 110 corresponding to the destination mobile device (not shown in FIG. 1).

Bearer flow 104 illustrates a connection between mobile devices on base transceiver stations served by the different Mobile Telephone Switching Offices, MTSO 101 and MTSO 170; the bearer flow 104 is also referred to as an inter-MTSO connection. The bearer flow 104 is similar to the intra-MTSO flow up until the signal reaches the MLS 160. At the MLS 160, however, the bearer flow 104 is routed through an external network, such as an Internet Protocol Wide Area Network (IP WAN) 165, to an MSC (not shown) in another MTSO 170 with which the destination mobile device (not shown) is associated.

As discussed earlier, service providers may be motivated to offer differentiating services requiring additional processing on various media types (e.g., voice, video). Towards this end intermediate network elements may be introduced to (1) monitor connection control signaling operating in the control plane for the establishment of connections bearing targeted media types and (2) to direct the bearer flows transporting these targeted connections to media processing points in the network where differentiated services can be applied.

Whether monitoring connection control signaling within a control plane or providing media processing services directly on bearer flow payloads, service disruption due to nodal failure of elements operating in either the control or data planes is preferably avoided. Further, the deployment of new systems into the control or data planes of networks employing legacy products adds further complexities in the form of additional interoperability criteria as well as increased network operational cost. In accordance with example embodiment(s) of the present invention, these concerns are addressed in an unobtrusive and transparent manner allowing for seamless integration as illustrated in FIGS. 2 through 11.

FIG. 2 is a network diagram illustrating a network 200 including a MTSO 201 in which an embodiment of the present invention may be deployed in either an inter-MTSO network flow 204 or intra-MTSO network flow 205. Following a network flow 204, 205, the network flow 204, 205 that begins at the base transceiver station 210 travels through a T1 backhaul 215 to a cross connect 220 in the MTSO 201. At the MTSO 201, the network flow 204, 205 is directed by a router 230 to an Ethernet switch 240 to the MSC 250. To the right of the MSC 250, the network flow 204, 205 is composed of packets carrying either signaling flows (e.g., SIP dialogs) carried within the context of the control plane or bearer flows transporting service bearing traffic within the context of the data plane.

Packets directed from or towards the MSC 250 via the network flows 204, 205 are routed to/from the Media Server 290 using either policy based routing or destination based routing functions on the MLS 260. Policy based routing is utilized for signaling flows arriving at the MLS 260 from either the MSC 250 or the IP WAN 265. Destination based routing is utilized for signaling flows arriving at the MLS 250 from the Media Server 290 and for bearer flows arriving from either the MSC 250 or the IP WAN 265. As such, policies may be employed by the MLS 260 to act autonomously on the signaling flows to “transparently” integrate the Media Server 290 into the control plane. Thus, the packets contained within these signaling flows are not directly addressed to the Media Server 290, but rather, the Media Server 290 “picks up” the packets contained with these signaling flows in a manner “transparent” to the connection endpoints (e.g., the origination and destination MSC's). The Media Server 290 may then modify these signaling packets to cause subsequent bearer flows to be directly sent to itself. As such, the Media Server 290 monitors signaling flows for certain connection set-up messages for targeted connections containing specific parameters (e.g., targeted media subtypes). Once a target connection has been so identified, the Media Server 290 modifies the set-up message pursuant to that connection to “draw” subsequent bearer flows carrying the target media for that connection to itself. Once so modified, these the packets containing these signaling message are presented back to the MLS 260, where they will be routed via destination based routing to their original destination—this by virtue of the fact that the original destination's addressing information has remained intact with the encapsulating packet. Note that the use of policy based routing ensures the continuity and reliability of signaling transmission across the control plane. In the event that the Media Server 290 experiences any sort of fault condition affecting its transmission links by which it connects to the MLS 260, the MLS 260 will not employ its configured policy based routing rule set, but, instead, defaults to destination based routing capabilities inherent to the MLS 260. Thus, the control plane packets “bypass” the faulted Media Server 290 altogether.

Subsequent to connection set-up, associated bearer flows arriving at the Media Server 290 may have their encoded media processed and/or modified by the Media Server 290 for the application of media enhancement services. Once so processed, these “enhanced” bearer packets are re-addressed and sent via the MLS 260 to their original connection endpoint as specified and whose packet addressing information was stored during the original connection set-up proceedings by the Media Server 290. This connection endpoint may be resident either locally in the MTSO 201 co-located MSC 250 or remotely on another MSC contained in a remote MTSO 270 located across the IP WAN 265. This technique can be applied to legacy networks and future networks.

In view of the foregoing, an example embodiment of the present invention includes a method or corresponding apparatus, or some combinations thereof, of transparently monitoring targeted bearer flows. The example method includes directing control plane signals according to policy-based routing associated with the control plane signals through a routing point in a network to a signaling monitoring point in the network. The example method also includes substituting bearer plane address information of a selected media processing point for bearer plane address information in the control plane signal in a manner causing subsequent bearer flows associated with the control plane signal to be directed to the selected media processing point from the routing point by destination based routing.

The method may also include directing bearer flows to a media processing point to process and encode a media signal on the bearer flows to monitor metrics associated with the encoded media signal. This example embodiment may further include adding information based on the metrics to produce an enhanced encoded media signal and outputting the enhanced encoded media signal.

The example method may further include directing bearer flows to a media processing point to apply signal enhancement to an encoded media signal on the bearer flows on the media processing point to produce and enhance encoded media signal and output the enhanced encoded media signal. Applying the encoded media signal enhancement may include applying Coded Domain-Media Quality Enhancement (CD-MQE).

The example method may further include selectively directing bearer flows to a media processing point, applying encoded media signal enhancement to a media encoded signal on the bearer flows at the media processing point to produce an enhanced encoded media signal, and outputting the enhanced encoded signal. A method may further include determining an identity of a sending or receiving party of targeted bearer flows, wherein selectively directing the bearer flows is based on the identity of at least one of the parties. Additionally or alternatively, the method may further include determining subscription features of originators of targeted bearer flows, wherein selectively directing the bearer flows is based on the subscription features. Moreover, the method may further include determining subscription features of destinations of targeted bearer flows, wherein selectively directing the bearer flows is based on the subscription features.

Subsequent bearer flows may occur within an Intra-Mobile Telephone Switching Office communications path, or within a communications path contained therein. Alternatively, the subsequent bearer flows may occur within an inter-mobile telephone switching office communications path or communications path contained therein. Policies associated with the control plane may be based on control plane origination or destination information.

It should be understood that subcombinations of the foregoing example methods are also within the scope of some example embodiments, such as substituting bearer plane address information of a selected media processing point for bearer plane information in control plane signals, received based on policy based routing, in a manner causing subsequent bearer flows associated with the control plane signals to be directed to the selected media processing point by destination based routing. In another example embodiment, in addition to the substituting, processing of an encoded or non-encoded media signal on the bearer flows may also be performed. It should be noted that the example embodiments are not limited to those expressly highlighted in this and the foregoing several paragraphs, but may be found expressly and impliedly within the application, drawings, and claims as presented herein.

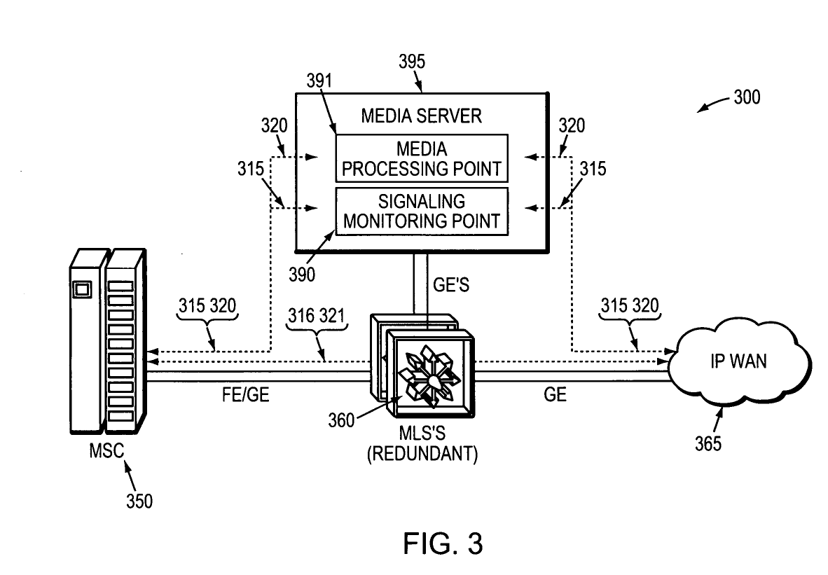

FIG. 3 illustrates an example system 300 in accordance with an example embodiment of the present invention that provides both a Signaling Monitoring Point 390 and a Media Processing Point 391 in association with connections between mobile devices served by the MTSO's 201, 270 of FIG. 2. In the system 300, an MSC 350 sends and receives packets 316, 321 to and from an MLS device 360 that routes both signaling messages 316 in the control plane and bearer flows 321 in the data plane between the MSC 350 and IP WAN 365. For network reliability purposes, the MLS device 360 may be configured as a redundant pair of MLS devices. The MLS device 360 may also route packets 316, 321 to and from a signaling monitoring point 390 as well as a media processing point 391, both of which in an embodiment of the present invention may be contained within the same element, the Media Server 395. Policy Based Routing (PBR) functions on the MLS's 360 can be configured to cause signaling messages 316 to be intercepted from passing directly between the MSC 350 and IP WAN 365 via the MLS's 360 and instead to be intercepted 315 to the Signaling Monitoring Point 390 residing on the Media Server 395. Signaling messages 315 arriving at the Signaling Monitoring Point 390 are scanned for connections being established whose bearer flows carry media types to be targeted for subsequent media processing. If found, the subsequent bearer flows 321, which would normally traverse within the data plane directly between the MSC 350 and IP WAN 365 via the MLS's 260, are instead directly routed 320 to the Media Processing Point 391 residing on the Media Server 395 via standard Destination Based Routing inherent to the MLS's 360. The media processing point 391 offers the opportunity to apply differentiating services to enhance the media contained in the bearer flows 320. In some embodiments of the present invention, the media processing point 391 may perform Coded Domain-Media Quality Enhancement (CD-MQE) services on the encoded media carried with the bearer flows 320 to produce an enhanced media.

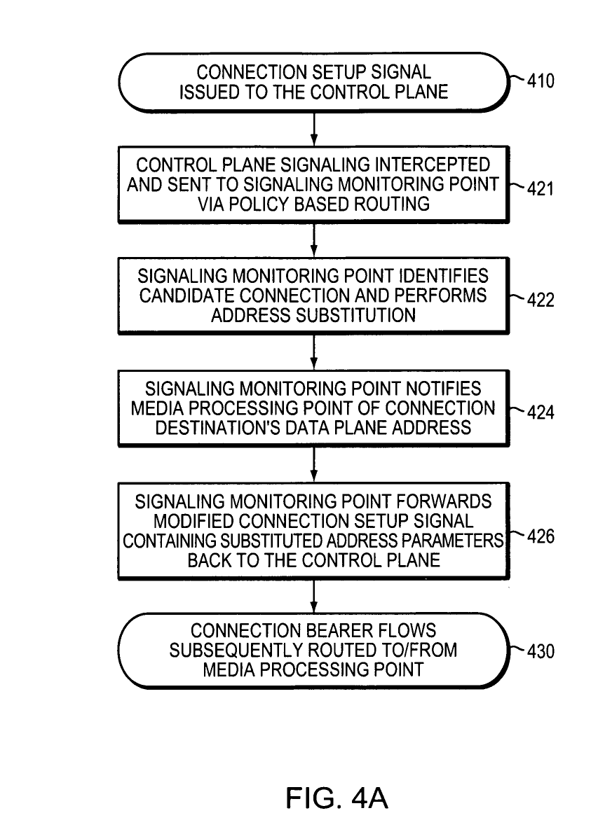

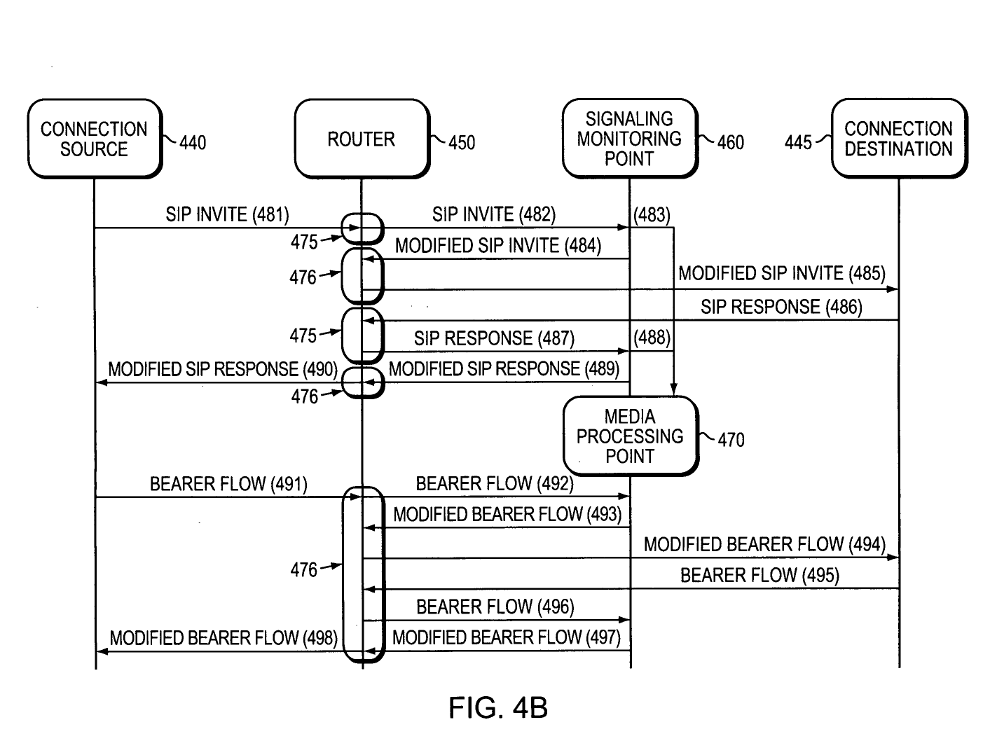

FIGS. 4A and 4B illustrate example network operations flow whereby (1) signaling messages in the control plane are transparently monitored to identify the set-up of connections as candidates for the application of media enhancement services and (2) the redirection of targeted bearer flows in the data plane of said candidate connections to a media processing point where media enhancement services can be applied.

FIG. 4A illustrates the operations flow in a call set-up to redirect bearer flows underlying targeted, candidate connections whereby:

(410) A control plane signal (e.g., SIP signal) is sent through the network to establish a new end-to-end connection.
(421) In accordance with an example embodiment of the present invention, the control plane signals are intercepted and redirected to a signaling monitoring point according to policies associated with the control plane signals.
(422) At the signaling monitoring point, after identifying a new connection set-up as a media enhancement candidate, data plane addressing parameters of a selected media processing point are substituted for the data plane addressing parameters of the connection endpoint contained in the connection set-up signal. This causes subsequent bearer flows to be directed to the selected media processing point from a routing point within the data plane by destination based routing once the connection is established.
(424) At the time that the media processing point's address substitution occurs, the signaling monitoring point also notifies the selected media processing point of the original data plane address parameters of the connection endpoint that were substituted for. This is so that the media processing point, once it has processed the media contained in a redirected bearer flow, may forward the enhanced media in bearer flow to its original connection endpoint as specified in the original signaling message.
(426) Once the signaling monitoring point is through with the connection control signal, the signal (containing its pertinent bearer flow addressing substitutions) will be forwarded to its original destination.
(430) Once the connection is established, associated bearer flows are routed directly to the selected media processing point at which point media enhancement services are applied to the encoded media. Subsequently, the enhanced encoded media are re-packetized into associated bearer flows for transmission to the connection endpoint whose data plane addressing parameters have previously been stored by the media processing point (per 424).

FIG. 4B further illustrates an example signal flow between a router 450 and a signaling monitoring point 460 in accordance with embodiments of the present invention. The connection source 440 initiates a control plane signal 481 (e.g., SIP Invite) towards the network to establish a new connection, and arrives at the router 450. The router 450 forwards the packet containing the SIP Invite 482 using Policy Based Routing (PBR) 475 to the signaling monitoring point 460. After identifying a new connection set-up as a media enhancement candidate based on media subtype parameters contained in the SIP Invite's 481 Session Descriptor, the signaling monitoring point 460 substitutes the data plane addressing parameters (i.e., IP Address, TCP/UDP port number) of a selected media processing point 470 for the data plane addressing parameters (i.e., IP Address, TCP/UDP port number) of the connection source 440 contained in the SIP Invite's 481 Session Descriptor. The signaling monitoring point 460 sends a notification 483 to the selected media processing point 470 of the original data plane addressing parameters (i.e., IP Address, TCP/UDP port number) of the connection source 440 that were substituted for. This is so that the media processing point 470, once it has processed the media contained in a redirected bearer flow 492, may forward the enhanced media in a bearer flow 493 to its original connection source 440 as specified in the original SIP Invite 482. Subsequent to this notification 483, the signaling monitoring point 460 then outputs the Modified SIP Invite 483 to the router 450, which forwards the Modified SIP Invite 484 via Destination Based Routing (DBR) 476 to its originally intended recipient, the Connection Destination 445.

At this point, the bearer flows from the connection destination 445 to the connection source 440 for the requested connection have been set-up. It is now time to set-up the other half of the requested connection by establishing the bearer flows from the connection source 440 to the connection destination 445. This is essentially the same signaling process (albeit with different SIP messages) in the reverse direction as was utilized to set-up the first half of the connection. Towards this end, the connection destination 445 initiates a control plane signal 486 (e.g., SIP Response) towards the network to respond to the Modified SIP Invite 485 and arrive at the router 450. The router 450 forwards the packet containing the SIP Response 487 using Policy Based Routing (PBR) 475 to the signaling monitoring point 460. The signaling monitoring point 460 substitutes the data plane addressing parameters (i.e., IP Address, TCP/UDP port number) of the selected media processing point 470 for the data plane addressing parameters (i.e., IP Address, TCP/UDP port number) of the connection destination 445 contained in the SIP Response's 487 Session Descriptor. The signaling monitoring point 460 sends a notification 488 to the selected media processing point 470 of the original data plane addressing parameters (i.e., IP Address, TCP/UDP port number) of the connection destination 445 that were substituted for. This is so that the media processing point 470, once it has processed the media contained in a redirected bearer flow 496, may forward the enhanced media in a bearer flow 497 to its original connection destination 445 as specified in the original SIP Response 487. Subsequent to this notification 488, the signaling monitoring point 460 then outputs the Modified SIP Response 489 to the router 450, which forwards the Modified SIP Response 490 via Destination Based Routing (DBR) 476 to its originally intended recipient, the Connection Source 440.

At this point, the data plane bearer flows supporting both directions of the connection between the connection source 440 and the connection destination 445 have been set-up. Media traffic transported by these bearer flows 491, 495 may now commence. Accordingly, the connection endpoints 440, 445 initiate packets within bearer flows 491, 495 towards the router 450, which forwards these bearer flows 492, 496 on to the media processing point 470 via Destination Based Routing (DBR) 476. As discussed previously, the media processing point 470 may provide media enhancement services (e.g., CD-VQE) to the media carried by these bearer flows 492, 496. Subsequently, the media processing point 470 performs a lookup of the data plane addressing parameters (i.e., IP Address, TCP/UDP port number) of the appropriate connection endpoint 440, 445 in order to construct a packet containing the modified media. The media processing point 470 then sends this packet within the Modified Bearer Flow 494, 497 back to the Router 450, which then forwards the Modified Bearer Flow 495, 498 via Destination Based Routing (DBR) 476 to the appropriate connection endpoint 440, 445.

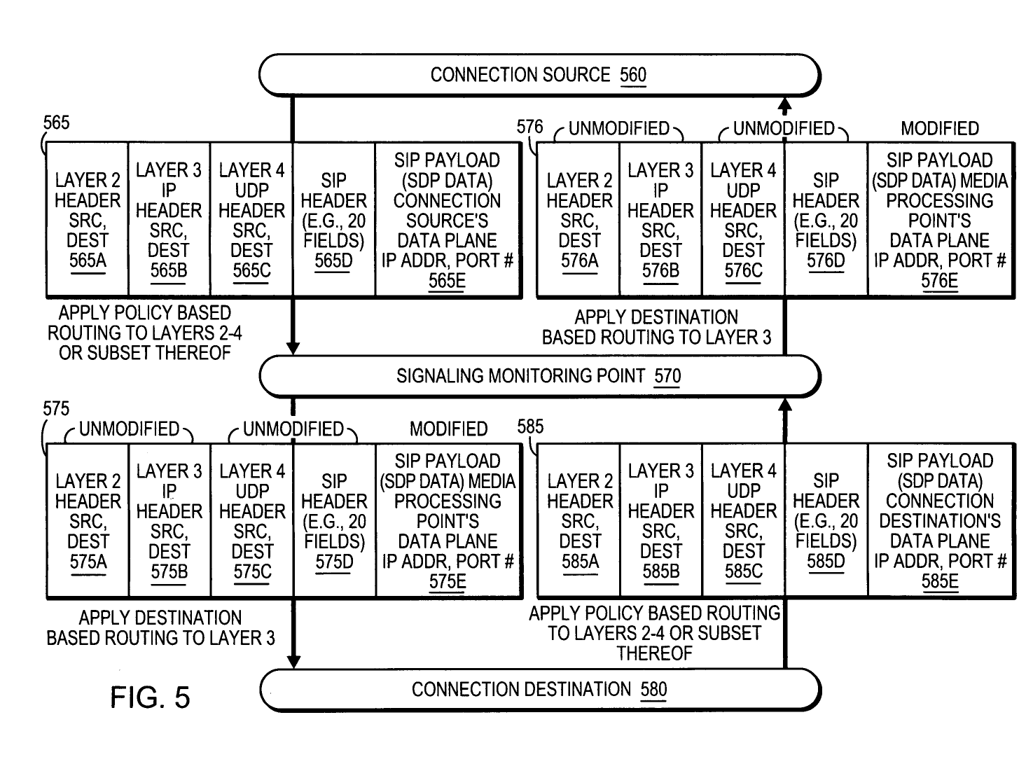

FIG. 5 illustrates example signaling packets (e.g., Session Initiation Protocol (SIP)) sent between a connection source 560 and a connection destination 580 across the control plane. In the example signaling packet of FIG. 5, the connection source 560 sends a SIP-laden packet 565 to the connection destination 580. The packet has layer 2 header information 565A, layer 3 Internet Protocol (IP) header information 565B, and layer 4 User Datagram Protocol UDP header information 565C. Included in these headers are source and destination addressing information pertaining to their respective layers. The UDP payload contains the SIP message composed of both a SIP header 565D, and the SIP payload 565E containing session description protocol (SDP) information. Among other attributes, the SDP contains the connection source's 560 data plane addressing information (i.e., IP address & UDP port number) to which the connection destination 580 should send its bearer flows. As discussed above with respect to FIG. 4B, in accordance with example embodiments of the present invention, a router (not shown in FIG. 5) may apply policy based routing to layers 2 through 4 (or a subset thereof) to the packet 565.

The signaling monitoring point 570 processes the incoming signaling packet 565 and sends out a modified signaling packet 575. Within the Session Descriptor of the SIP message 565, the signaling monitoring point 570 replaces the connection source's 560 data plane IP Address and User Datagram Protocol (UDP) Port Number with data plane addressing parameters of the selected media processing point. Thus, the signaling packet 575 sent from the signaling monitoring point 570 provides the connection destination 580 with the media processing point's data plane IP address and UDP port number to which the connection destination 580 should send its bearer flows. The layers 2, 3, 4, and SIP headers of the signaling packet 565 received by the signaling monitoring point 570 remain unchanged in the headers 575A, 575B, 575C, 575D contained in the signaling packet 575 transmitted by the signaling monitoring point 570. With respect to FIG. 4B, by leaving these headers unmodified between signaling packets 565 and 575, a router (not shown in FIG. 5) may apply destination based routing to send the modified signaling packet to the connection destination 580 as was intended by the connection source's 560 issuance of signaling packet 565.

The connection destination 580 receives and processes the signaling packet 575, and subsequently sends to the connection source 560 a signaling packet 585 to initiate the other half of the connection in the opposite direction. This signaling packet 585 response traverses the control plane in the opposite direction than did the original signaling packet 565 as initiated by the connection source 560. After being intercepted to the signaling monitoring point 570 via Policy Based Routing per FIG. 4B, the modified signaling packet 576 response arrives at the connection source 560, thus completing the connection set-up. At this point, bearer flows may commence in both directions of transmission.

Furthermore, with respect to FIG. 4B, in accordance with example embodiments of the present invention, in the eventuality that signaling monitoring point 570 fails, a router (not shown in FIG. 5) no longer applies policy based routing and, instead, defaults to the destination based routing, thus bypassing the failed signaling monitoring point 570 altogether. This ensures the continuity of the control plane between the connection endpoints 560, 580.

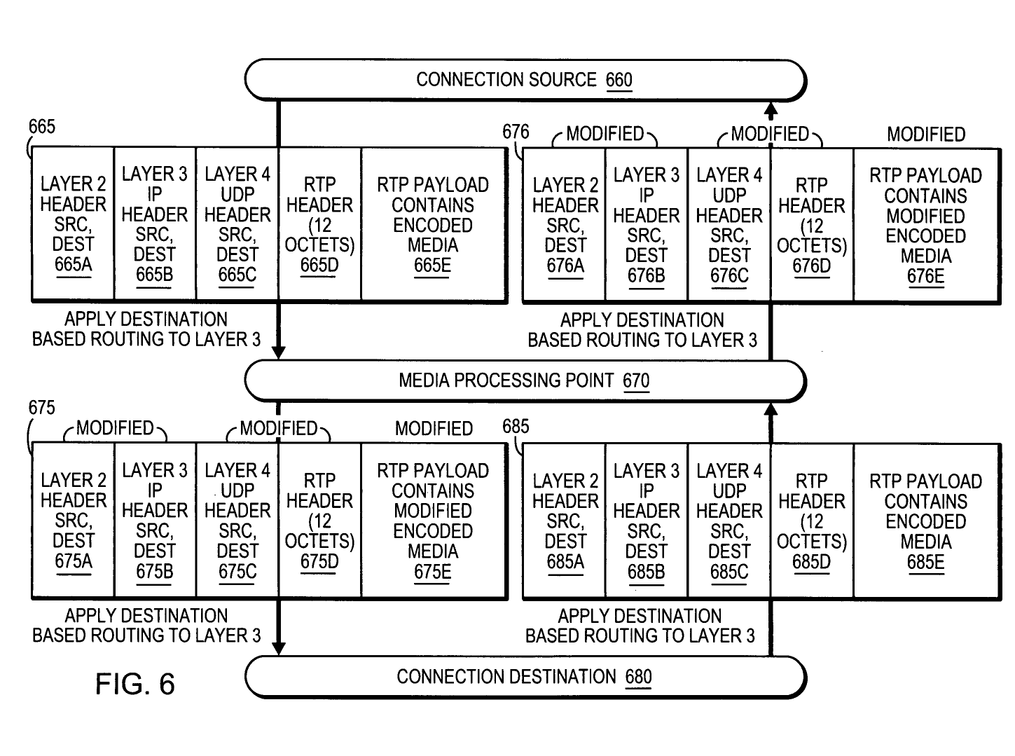

FIG. 6 is a packet diagram illustrating bearer channel packets sent between a connection source 660 and a connection destination 680 with intervening media processing functions 670 applied. Once the session is established as shown in FIG. 5, bearer flow packets 665, 685 are initiated by the connection endpoints 660, 680 to the media processing point 670 where media enhancement services may be applied. Subsequent to these enhancements, the media processing point formulates bearer flow packets 675, 676 containing the enhanced encoded media and sends these packets on to their respective connection endpoints 680, 660.

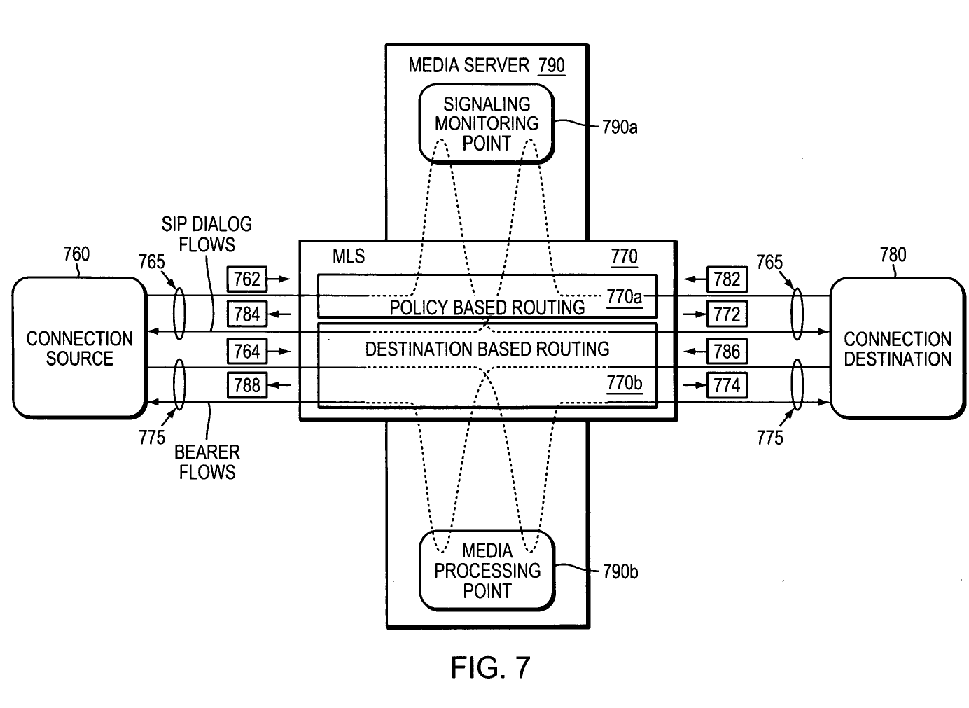

FIG. 7 illustrates session initiation protocol (SIP) 765 dialog flows and the bearer flows 775 through a multilayer switching device (MLS) 770 according to an example embodiment of the present invention. A connection source 760 transmits a SIP packet 762 along a SIP dialog flow 765. At an MLS device 770, in accordance FIGS. 4A & 4B, a policy based routing module 770a forwards the SIP packet 762 to a signaling monitoring point 790a contained within the Media Server 790. The signaling monitoring point 790a modifies the SIP descriptor information as discussed previously with respect to the signaling monitoring point of FIGS. 4A, 4B, and 5 and sends the modified SIP packet 772 along the SIP dialog flow through the MLS 770, where, in accordance FIG. 4B, a destination based routing module 770b forwards the SIP packet 772 routed to the connection destination 780. The connection destination 780 likewise responds by sending a SIP packet 782 to the MLS 770, where again in accordance FIGS. 4A & 4B, a policy based routing module 770a forwards the SIP packet 782 to the signaling monitoring point 790a contained within the Media Server 790. The signaling monitoring point 790a processes the packet 782, accordingly, and sends it back to the MLS 770, where again a destination based routing module 770b forwards the SIP packet 782 to the connection source 760.

After the connection is established, the connection source 760 sends and receives media bearing packets 764, 788 within bearer flows 775 to and from the media processing point 790b within the Media Server 790 via the MLS 770. Similarly, the connection destination 780 sends and receives media bearing packets 786, 774 within bearer flows 775 to and from the media processing point 790b within the Media Server 790 via the MLS 770. In this example embodiment, the MLS 770 forwards any arriving media bearing packets 764, 786 via a destination based routing module 770b to the media processing point 790b within the Media Server. At the media processing point 790b, the media contained with media bearing packets 764, 786 may be extracted and/or altered prior to sending the modified media via media bearing packets 774, 788 to the respective connection endpoints 760, 780.

Certain aspects of the example embodiments of the present invention, such as applying policy based routing, then destination based routing, may be implemented in a form of software, firmware, or hardware. If implemented in software, the software may be written in any language suitable to support operations consistent with those described herein. The software may be stored as computer readable instructions on any form of computer-readable medium, loaded by a processor, and executed by the processor or on multiple processors in a manner understood in the art. The processor(s) may be any form of general purpose or custom designed processor(s) suitable to perform operations illustrated by way of examples herein.

While this invention has been particularly shown and described with references to example embodiments thereof, it will be understood by those skilled in the art that various changes in form and details may be made therein without departing from the scope of the invention encompassed by the appended claims.

1. A method of transparently monitoring targeted bearer flows, comprising:
directing control plane signals according to policy based routing associated with the control plane signals through a routing point in a network to a signaling monitoring point in the network; and
substituting bearer plane address information of a selected media processing point for bearer plane address information in the control plane signal in a manner causing subsequent bearer flows associated with the control plane signal to be directed to the selected media processing point from the routing point by destination based routing.

2. The method of claim 1 further comprising:
directing bearer flows to a media processing point to process an encoded media signal on the bearer flows to monitor metrics associated with the encoded media signal.

3. The method of claim 2 further comprising
adding information based on the metrics to produce an enhanced encoded media signal; and
outputting the enhanced encoded media signal.

4. The method of claim 1 further comprising:
directing bearer flows to a media processing point to apply signal enhancement to an encoded media signal on the bearer flows at the media processing point to produce an enhanced encoded media signal; and
outputting the enhanced encoded media signal.

5. The method of claim 4 wherein applying the encoded media signal enhancement includes Coded Domain-Media Quality Enhancement (CD-MQE).

6. The method of claim 1 further comprising:
selectively directing bearer flows to a media processing point;
applying encoded media signal enhancement to a media encoded signal on the bearer flows at the media processing point to produce an enhanced encoded media signal; and
outputting the enhanced encoded signal.

7. The method of claim 6 further including determining an identity of a sending or receiving party of targeted bearer flows wherein selectively directing the bearer flows is based on the identity of at least one of the parties.

8. The method of claim 6 further including determining subscription features of originators of targeted bearer flows wherein selectively directing the bearer flows is based on the subscription features.

9. The method of claim 6 further including determining subscription features of destinations of targeted bearer flows wherein selectively directing the bearer flows is based on the subscription features.

10. The method of claim 1 wherein the subsequent bearer flows occur within an Intra-Mobile Telephone Switching Office communications path.

11. The method of claim 1 wherein the subsequent bearer flows occur within an Inter-Mobile Telephone Switching Office communications path.

12. The method of claim 1 wherein policies associated with the control plane are based on control plane signal origination information.

13. The method of claim 1 wherein policies associated with the control plane are based on control plane signal destination information.

14. A system for transparently monitoring targeted bearer flows in a network, comprising:
a router configured to direct control plane signals according to policies associated with the control plane signals; and
a signaling monitoring point configured to receive control plane signals from the router and to substitute bearer plane address information of a selected media processing point for bearer plane address information in the control plane signals in a manner causing subsequent bearer flows associated with the control plane signal to be directed to the selected media processing point from the router by destination based routing.

15. The system of claim 14 further comprising:
a media processing point configured to receive bearer flows from the media processing point and to process a media encoded signal on the bearer flows to monitor metrics associated with the encoded media signal.

16. The system of claim 15 wherein the media processing point is further configured to add information based on the metrics to produce an enhanced encoded media signal and output the enhanced encoded media signal.

17. The system of claim 14 further comprising:
a media processing point configured to receive bearer flows and to apply signal enhancement to a media encoded signal on the bearer flows to produce an enhanced encoded media signal.

18. The system of claim 17 wherein the signal enhancement is Coded Domain-Media Quality Enhancement (CD-MQE).

19. The system of claim 17 wherein the signaling monitoring point is further configured to direct bearer flows selectively to a selected media processing point.

20. The system of claim 19 wherein the signaling monitoring point is configured to direct the bearer flows selectively based on the identity of a party to the targeted bearer flow.

21. The system of claim 19 wherein the signaling monitoring point is configured to direct the bearer flows selectively based on subscription features of originators of targeted bearer flows.

22. The system of claim 19 wherein the signaling monitoring point is configured to direct bearer flows selectively based on subscription features of destinations of the targeted data plane flows.

23. The system of claim 17 wherein the subsequent bearer flows between the router and media processing point occur within an Intra-Mobile Telephone Switching Office communications path.

24. The system of claim 17 wherein the subsequent bearer flows between the router and media processing point occur within an Inter-Mobile Telephone Switching Office communications path.

25. The system of claim 17 wherein policies associated with the control plane are based on control plane signal origination information.

26. The system of claim 17 wherein policies associated with the control plane are based on control plane signal destination information.

27.-52. (canceled)
